(19) United States
(12) Patent Application Publication
(10) Pub. No.: US 2011/0283894 A1
(43) Pub. Date: Nov. 24, 2011

(54) CONVEYOR OVEN AND CONVEYOR BELT FOR CONVEYOR OVEN

(76) Inventors: William S. Schjerven, SR., Schaumburg, IL (US); Theodore James Chmiola, Roscoe, IL (US); Mark A. Sieron, Arlington Heights, IL (US)

(21) Appl. No.: 13/112,798

(22) Filed: May 20, 2011

Related U.S. Application Data
(60) Provisional application No. 61/347,211, filed on May 21, 2010.

(51) Int. Cl. A21B 1/48

(52) U.S. Cl. 99/443 C

(57) ABSTRACT

A conveyor belt for use in a conveyor oven used to cook food products. The conveyor belt includes a plurality of spiral members each coupled to one another by a plurality of laterally extending cross supports and where the ratio of the portion of the surface area of the conveyor belt in contact with a food product (A_{Contact}) to the portion of the surface area of the conveyor belt covered by the food product (A_{Belt}) is between about 0.1 and about 0.2.

### CROSS-REFERENCE TO RELATED APPLICATIONS

This application claims the benefit of and priority from U.S. Provisional Patent Application No. 61/347,211 filed May 21, 2011, the entire contents of which are hereby incorporated by reference.

### BACKGROUND

Conveyor ovens are commonly used for cooking a wide variety of food products, such as for cooking pizzas, baking and toasting bread, and the like. Examples of such ovens are shown, for example, in International Patent Application No. PCT/2009/030727, the entire contents of which are incorporated herein by reference.

Conveyor ovens typically have metallic housings with a heated tunnel extending therethrough, and one or more conveyors running through the tunnel. Each conveyor (in the form of a conveyor belt, for example) transports food items through the heated oven tunnel at a speed calculated to properly bake food on the conveyor belt during the time the conveyor carries the food through the oven. Conveyor ovens generally include a heat delivery system that may include one or more blowers supplying heated air to the tunnel, such as from a plenum to the tunnel. In some conveyor ovens, hot air is supplied to the tunnel through passageways that lead to metal fingers discharging air into the tunnel at locations above and/or below the conveyor. The metal fingers act as airflow channels that deliver streams of hot air which impinge upon the surfaces of the food items passing through the tunnel on the conveyor. In modern conveyor ovens, a microprocessor-driven control can be employed to enable the user to regulate the heat provided to the tunnel, the speed of the conveyor, and other parameters to properly bake the food item being transported through the oven.

### SUMMARY OF THE INVENTION

Some embodiments of the present invention may provide a conveyor oven for cooking food products. The conveyor oven including a housing, a cooking tunnel extending through the housing, a heating element, and a conveyor belt extending through the tunnel and having a surface area configured to support the food product thereon. Where the ratio of the portion of the surface area of the conveyor belt in contact with a food product (A_{Contact}) to the portion of the surface area of the conveyor belt covered by the food product (A_{Belt}) is between about 0.1 and about 0.2.

Other embodiments of the present invention may provide a conveyor oven for cooking food product. The conveyor oven including a housing, a cooking tunnel extending through the housing, a heating element, and a conveyor belt extending through the tunnel and having an upper portion including a surface configured to support the food product and a plurality of spaces formed therethrough which an axis normal to the support plane may pass without intersecting any material. Where the ratio of the combined area of the spaces of the support surface (A_{PT}) to the total area of the support surface (W_{Belt}*L_{Belt}) is between about 0.5 and about 0.65.

Still other embodiments of the present invention may provide a conveyor oven for cooking food products. The conveyor oven including a housing, a cooking tunnel extending through the housing, a heating element, and a conveyor belt extending through the tunnel and having a surface area configured to support the food product thereon. Where the conveyor belt is formed from wire defining a first width and including a contact surface defining a second width, and where the second width of the contact surface is at least about 90% of the first width.

### BRIEF DESCRIPTION OF THE DRAWINGS

FIG. 1 is a perspective view of a conveyor oven in accordance with an embodiment of the invention.

FIG. 2 is a perspective view of a portion of the conveyor oven of FIG. 1, in which a hinged oven access panel has been opened to reveal some of the internal components of the oven.

FIG. 3 is a diagrammatic representation of the tunnel of the conveyor oven of FIG. 1.

FIG. 4 is a side view of the internal compartments of the conveyor oven of FIG. 1.

FIG. 5 is an end view of the conveyor oven with a food item placed on the conveyor belt.

FIG. 6 is a detailed view of the conveyor belt of the conveyor oven of FIG. 1.

FIG. 7 is a top view of a spiral member of the conveyor belt of FIG. 6.

FIG. 8 is an end view of the spiral member of FIG. 7.

FIG. 9 is a section view taken along lines 9-9 of FIG. 7.

FIG. 10 is a side view of a portion of the conveyor belt of FIG. 6.

### DETAILED DESCRIPTION

Before any embodiments of the present invention are explained in detail, it is to be understood that the invention is not limited in its application to the details of construction and the arrangement of components set forth in the following description or illustrated in the following drawings. The invention is capable of other embodiments and of being practiced or of being carried out in various ways.

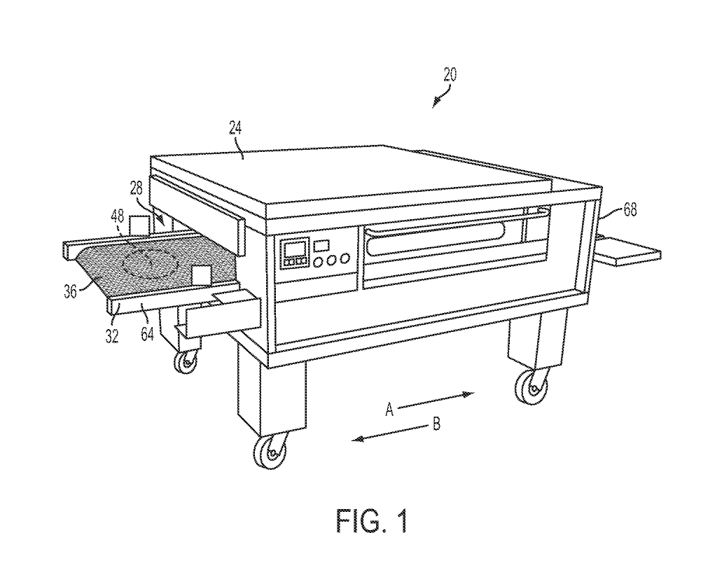

FIG. 1 illustrates a conveyor oven 20 of the present invention having a housing 24 with a cooking tunnel 28 extending therethrough. The conveyor oven 20 also includes a conveyor assembly 32 extending through the tunnel 28, the conveyor assembly 32 having a conveyor belt 36 (described below) to convey food items 48 through the tunnel 28 at a speed calculated to properly bake the food.

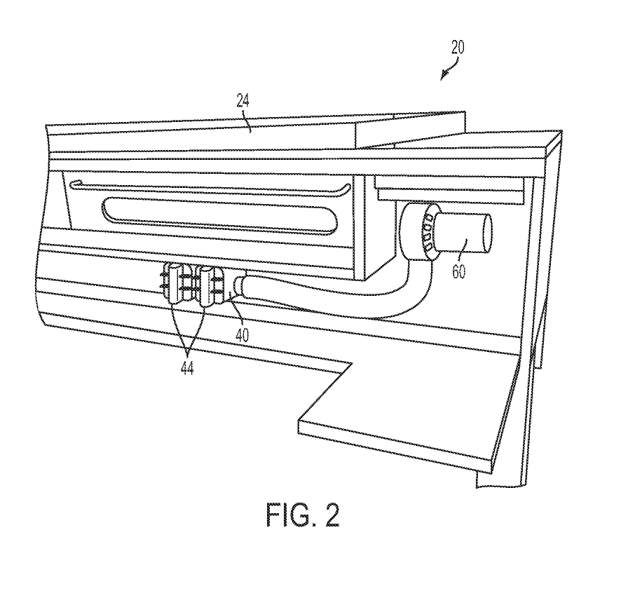

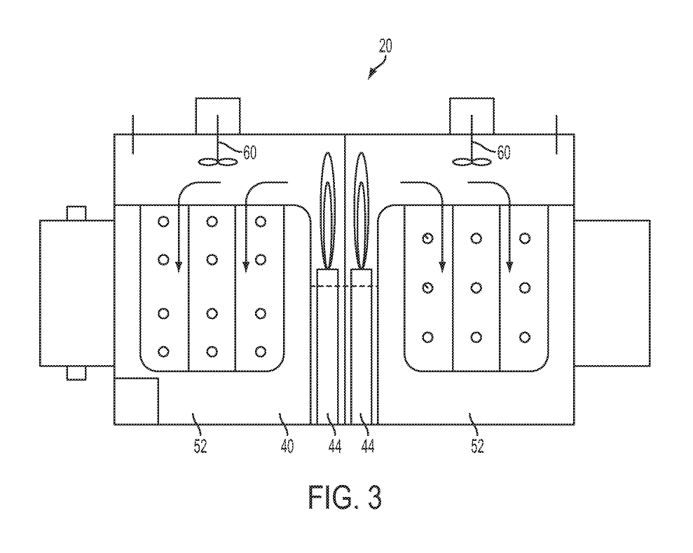

The conveyor oven 20 also includes a heat delivery system 40 for supply of heat to the tunnel 28 (see FIGS. 2-4) to cook the food items 48. The illustrated heat delivery system 40 includes a plurality of burners 44 supplying heat to a plenum 52. The heated air from the plenum 52 is then blown by one or more blower fans 60 into a plurality of fingers 56 positioned above and below the conveyor belt 36, although any other position(s) of fingers 56 or other hot air delivery elements or convection heating systems are possible, and fall within the spirit and scope of the present invention.

The conveyor assembly 32 of the conveyor oven 20 is generally the width of the tunnel 28, and is designed to travel in direction A from left oven end 64 toward right oven end 68 or, alternatively in direction B, from right oven end 68 toward left oven end 64. Thus, oven ends 64 and 68 may serve respectively as the inlet and outlet of an oven 20 with a rightwardly moving conveyor belt 36 or as the outlet and inlet of an oven 20 with a leftwardly moving conveyor belt 36. Although the conveyor oven 20 illustrated in FIG. 1 has only a single conveyor assembly 32, any number of additional conveyor assemblies 32 in any desired arrangement can be used in other embodiments.

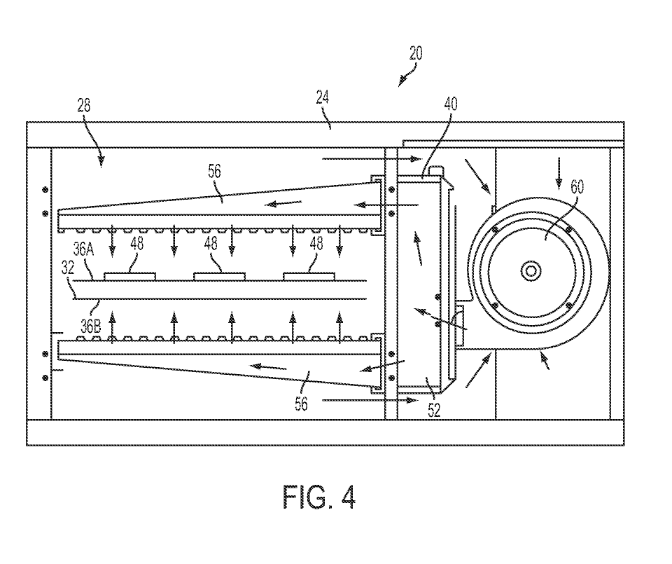

Illustrated in FIG. 4, the conveyor belt 36 forms a continuous loop and includes an upper portion 36a to support the food product to be conveyed through the oven tunnel 28, and a lower portion 36b. The upper portion 36a of the conveyor belt 36 thus provides a support surface 96 for the food product to be cooked.

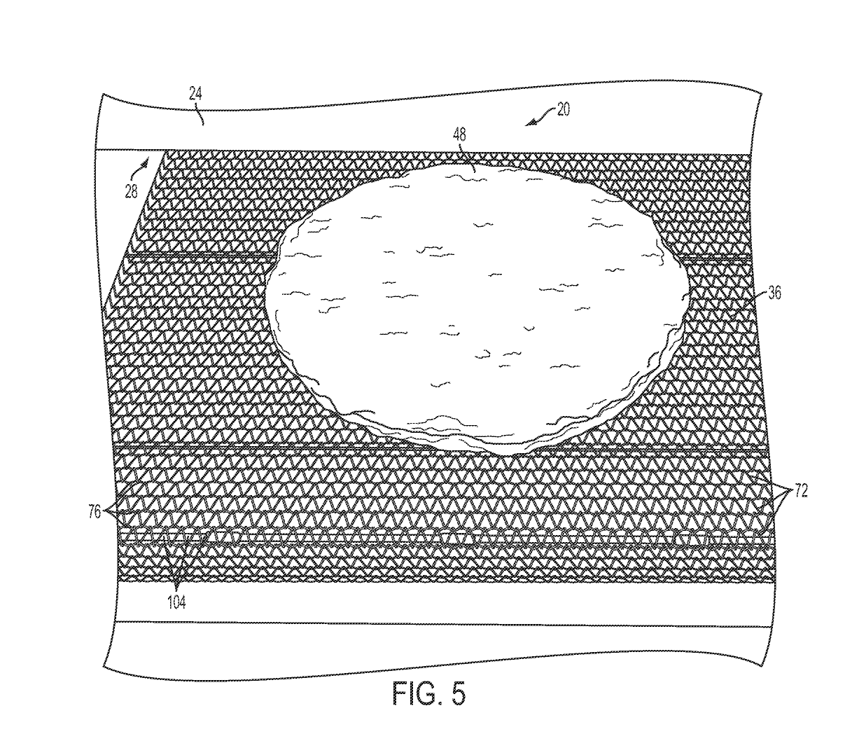

Referring to the illustrated embodiment of FIGS. 5-10, the conveyor belt 36 of the conveyor assembly 32 is configured to support one or more food items 48, and to convey the food items through the tunnel 28 of the conveyor oven 20. The conveyor belt 36 is also configured to at least partially cook the bottom portion of the food items 48 placed thereupon. As will be described in greater detail below, the conveyor belt 36 is configured to at least partially cook food items 48 placed thereupon by virtue of the construction of the conveyor belt 36 permitting airflow through the conveyor belt 36 and onto underside surfaces of food items 48 thereon. In some embodiments, the conveyor belt 36 is also constructed of a material and is shaped to cook food items 48 placed thereon by heat conduction (i.e., through direct contact between the conveyor belt 36 and the underside surfaces of the food items F thereon).

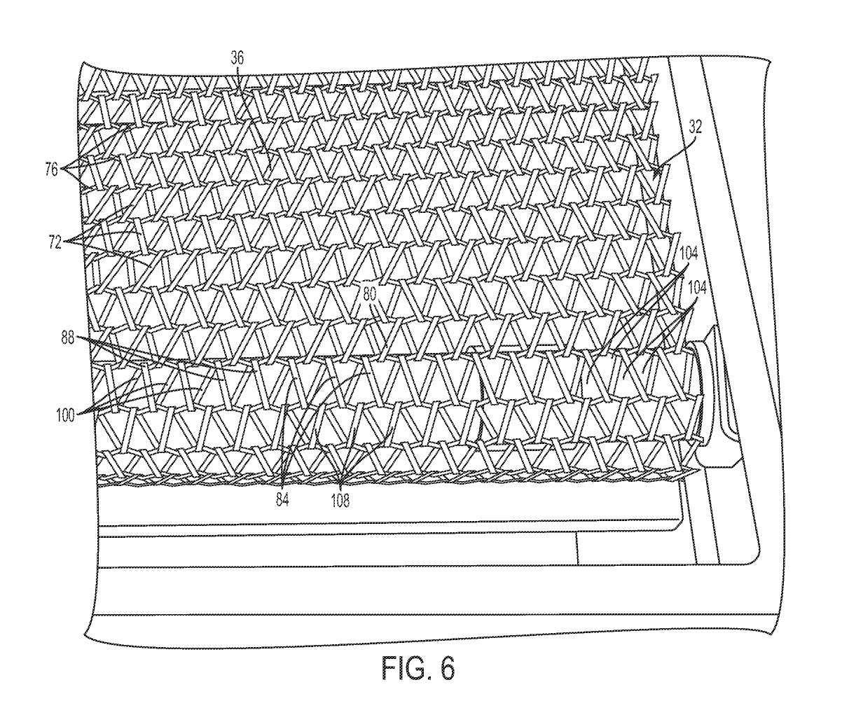

In the illustrated embodiment, the conveyor belt 36 is formed from a network of spiral members 72 (see FIGS. 6-8), each coupled to one another by a plurality of laterally extending cross supports 76. The spiral members 72 may be coiled in either a clockwise manner or in a counter-clockwise manner about adjacent cross supports 76. In some embodiments, all spiral members 72 of the conveyor belt 36 are wound in the same direction (e.g., clockwise or counter-clockwise). However, in other embodiments, a combination of clockwise and counter-clockwise spiral members 72 are used, such as in the illustrated embodiment, where clockwise spiral members 72 alternate with counter-clockwise spiral members 72 along the length of the conveyor belt 36. Any such alternating pattern of spiral members 72 can be used, and falls within the spirit and scope of the present invention.

The spiral members 72 can each be formed from an elongated piece of material, such as a wire 80 (described in greater detail below). In some embodiments, the spiral members 72 are formed into a substantially “flat spiral” shape (see FIG. 8), where individual runs of each spiral member 72 are substantially straight and/or substantially co-planar to the plane of the conveyor belt 36 when the conveyor belt 36 is oriented in a straight direction. These individual runs can be connected by curved portions extending about the cross supports 76 to define the overall shape of each spiral member 72.

In some embodiments, each of the spiral members 72 forms a plurality of flattened ovular coils 84 each having a top portion 88 positioned proximate a support plane 92 upon which food items F rest (i.e., at least partially defining the support surface 96), and a lower portion 100 opposite thereof.

With continued reference to the conveyor belt shown in FIGS. 5-10, the cross supports 76 of the illustrated conveyor belt 36 are each substantially undulating in shape, thereby defining a plurality of alternating peaks and valleys along the length of each cross-support 76 (see FIG. 6). In the illustrated embodiment, each peak and valley pair is configured to at least partially engage a portion of two adjacent spiral members 72.

By utilizing cross supports 76 having undulating shapes about which spiral members 72 are wound, lateral motion of the spiral members 72 is inhibited. This can be particularly advantageous when the conveyor belt 36 is tilted from a horizontal position, such as when the conveyor belt 36 is rolled up and placed on end. Furthermore, the undulating shape of the cross supports 76 can provide a desirable increase in strength and/or rigidity to the conveyor belt 36 as wound with the spiral members 72 described herein.

It will be appreciated that the spaces between the spiral members 72 and the cross-supports 76 at least partially define the ability of air to flow through the conveyor belt 36. These spaces are in turn at least partially defined by the pitch of the spiral members 72 (otherwise expressed as the distance between peaks of a spiral member 72), the width of the spiral members 72, the width of the cross supports 76, and the distance between cross supports 76. As used herein, the term “width” (in connection with describing the spiral members 72 and the cross supports 76) refers to the smallest dimension of the element in the plane of the conveyor belt 36.

Improved cooking results are achieved when specific amounts of space are provided through the conveyor belt 36 for passage of heated air—and therefore for cooking the underside of food items 48 on the conveyor belt 36 by convection. Such space can be expressed in different manners. In general, however, a conveyor belt 36 having an aggregate amount of space through which air can flow that is no less than about 50% of the planar area of the conveyor belt 36 has been found to produce desirable results (e.g., when viewed normal to the support surface 96). In some embodiments, this amount of space is no less than about 55%. Also in some embodiments, this amount of space is no greater than about 65%. In still other embodiments, this amount of space is approximately 56%.

The amount of space through which air can flow through the conveyor belt 36 expressed as a ratio of space to total conveyor belt surface area is referred to herein as a “pass through ratio.” In other words, the pass through ratio is defined as the aggregate area of the belt 36 through which air can pass freely (when viewed normal to the support surface 96) over the overall two-dimensional size of the conveyor belt 36 in that area. More specifically, the pass through ratio can be expressed as the ratio of A_{PT} over a corresponding total area of the conveyor belt 36, where A_{PT} represents the combined area of the spaces through the upper portion 36a of the belt that an axis positioned normal to the plane 92, may pass through the upper portion 36a of the conveyor belt without intersecting any material (e.g., see pass through areas 104 in FIG. 6). Accordingly, the pass through ratio can be defined as A_{PT}/(W_{Belt}*L_{Belt}), with W_{Belt}*L_{Belt} as the corresponding total area of the conveyor belt 36 in which A_{PT} is measured.

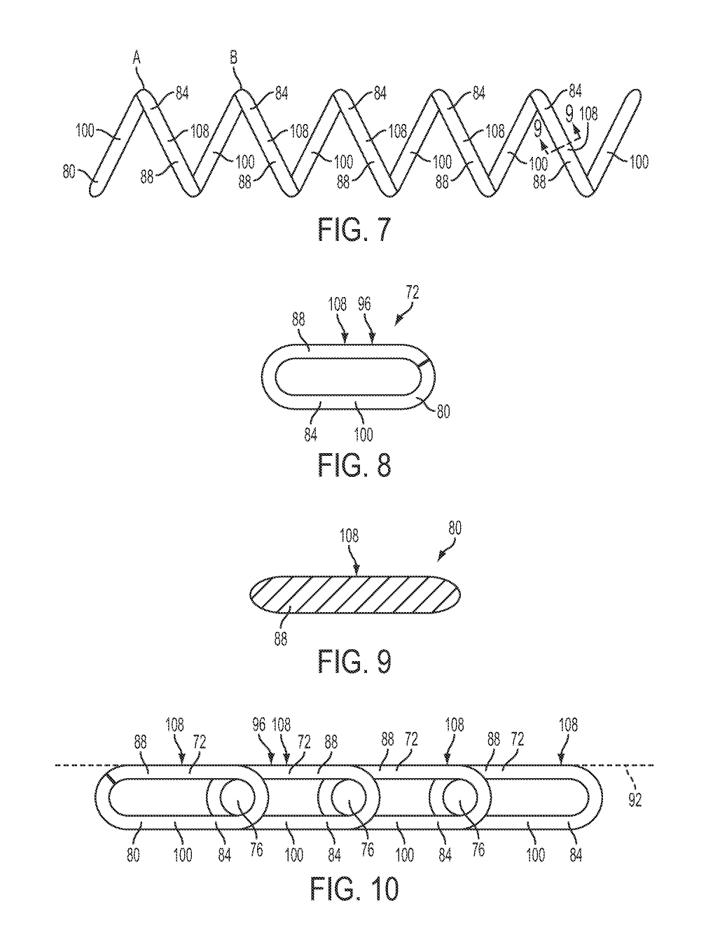

Another metric of airflow capability through the conveyor belt 36 is the ratio of the distance between adjacent runs (or peaks or valleys) of a spiral member 72 to the width of the spiral member 72. This metric is called the “coil separation ratio” herein. More specifically, the coil separation ratio can be defined as D_{AB}/W_{Spiral}, where D_{AB} is defined as the distance between two adjacent runs (or peaks and valleys) (e.g., point A to point B, see FIG. 7) of a spiral member 72, and W_{Spiral} is the width of the spiral member 72 as described above.

In some embodiments, the “coil separation ratio” of each spiral member 72 is no less than about 0.66 and is no greater than about 0.78. In other embodiments, each spiral member 72 has a coil separation ratio of no less than about 0.68 and no greater than about 0.76. Also, in some embodiments, each spiral member 72 has a coil separation ratio of 0.72.

Yet another metric of airflow capability is the ratio of the distance between adjacent runs (as described above) of the spiral member 72 to the diameter or width of the wire 80 used to form the spiral member 72. This metric is called the “coil concentration ratio” herein. More specifically, the coil concentration ratio can be defined as D_{AB}/D_{Wire} where D_{AB} is the same as described above, and D_{Wire} is the diameter of the wire 80 forming the spiral member 72. In embodiments where the wire 80 does not have a substantially circular cross section, the planar width W_{Planar} (see FIG. 9) may be used. The planar width is defined as the largest width of the wire 80 co-planar with the support plane 92.

In some embodiments, the “coil concentration ratio” of each spiral member 72 is no less than about 4.8 and is no greater than about 5.4. In other embodiments, each spiral member 72 has a coil concentration ratio of no less than about 5.0 and no greater than about 5.2. Also, in some embodiments, each spiral member 72 has a coil concentration ratio of no less than about 5.1.

Yet another metric of airflow capability through the conveyor belt 36 is coil density, or the number of coils 84 of each spiral member 72 per unit length across the width of the conveyor belt 36. In some embodiments, the coil density of the spiral members 72 is no less than about 2 and is no greater than about 2.8 coils per inch. In other embodiments, each spiral member 72 has a coil density of no less than about 2.2 and no greater than about 2.6 coils per inch. Also, in some embodiments, each spiral member 72 has a coil density of no less than about 2.4 coils per inch.

Yet another metric of airflow capability through the conveyor belt 36 is the average aperture size Ā_{Aperture} of the belt 36. Ā_{Aperture} is defined as the average surface area of each pass through area 104 (described above) when projected onto the support plane 92. In some embodiments, Ā_{Aperture} of the belt 36 is no less than about 0.044 in² and is no greater than about 0.05 in². In other embodiments, Ā_{Aperture} of the belt 36 is no less than about 0.045 in² and no greater than about 0.049 in². Also, in some embodiments, Ā_{Aperture} of the belt 36 is no less than about 0.047 in².

As described above, the illustrated conveyor belt 36 is configured to also cook food items 48 placed thereon by direct contact with the food items. Although some level of conveyor belt heating is inherent in conventional conveyor oven conveyor belts, the inventors have found that an appropriate balance between the individual and aggregate sizes of spaces through which heated air flows to the food items 48 (as described above) and the shapes and sizes of the conveyor belt parts that contact the food items 48 produce remarkable and highly desirable results in cooking the food items.

With reference to the illustrated embodiment of FIGS. 5-10 by way of example, during operation of the conveyor oven 20, the conveyor belt 36 absorbs energy from heat-generating elements of the conveyor oven 20 (e.g., burners 44, infrared heating elements, and the like), thereby increasing in temperature and transferring heat to food items on the conveyor belt 36 by direct contact (conduction) and to some degree by radiant heating.

It will be appreciated that the shapes of the spiral member portions contacting food items on the conveyor belt 36 are determined at least in part by the cross-sectional shape of the top portion 88 of each spiral member 72. For example, in some embodiments, the top portion 88 of each spiral member 72 has a substantially round cross-sectional shape. In such cases, contact between each spiral member 72 and food items 48 thereon is substantially linear or is otherwise relatively elongated and narrow. As another example, in other embodiments, the top portion 88 of each spiral member 72 has a cross-sectional shape with a substantially flat top. In such cases, the contact area between each spiral member 72 and food items placed thereon is significantly wider, and therefore more substantial.

Improved cooking performance is achieved with increased surface area contact between food items 48 and the spiral members 72 of the conveyor belt 36 (especially when taken in conjunction with the airflow metrics described above). To this end, increased surface area provided by flat tops of the spiral members 72 significantly improved cooking performance of the conveyor oven.

As stated above, the spiral members 72 can each be formed from a length of metallic wire 80. In some embodiments, at least the top surface of each wire 80 (and in some cases, the top and bottom surfaces of each wire 80) can be substantially flat. In the illustrated embodiment, for example, the wire 80 is substantially ribbon-like, having at least one substantially flat contact surface 108 (see FIG. 9) on which the food is supported (e.g., co-planar with the support plane 92).

In some embodiments, the width of the upper surface W_{SS} is at least about 90% of the planar width W_{Planar} of the wire 80 (e.g., W_{US}/W_{Planar}>90%). In other embodiments, the width of the upper surface W_{SS} is at least about 95% of the planar width W_{Planar} of the wire 80 (e.g., W_{US}/W_{Planar}>95%). In still other embodiments, the width of the upper surface W_{SS} is at least about 97% of the planar width W_{Planar} of the wire 80 (e.g., W_{US}/W_{Planar}>97%).

The width to height ratio of the wire 80 of each spiral member 72 has also been found to be significant to the conductive cooking ability and quality of the conveyor belt 36. In some embodiments, the wire 80 includes a width to height ratio (W_{Wire}/H_{Wire}) of at least about 1.6. In other embodiments, the wire 80 includes a width to height ratio (W_{Wire}/H_{Wire}) of at least about 1.7. In still other embodiments, the wire 80 includes a width to height ratio (W_{Wire}/H_{Wire}) of at least about 1.8.

Another manner of expressing the amount of contact area between the conveyor belt 36 and food items 48 placed thereon is referred to herein as the “contact ratio”. The contact ratio is defined as the ratio of the combined area of the conveyor belt 36 contacting a food item 48 over the total area of the conveyor belt 36 covered by the food item. More specifically, the contact ratio is defined as (A_{Contact})/(A_{Belt}), where A_{Belt} is the total area of the conveyor belt 36 covered by the food item, and A_{Contact} is the combined surface area of the spiral members 72 in physical contact with the food item in the area of A_{Belt}. In some embodiments, the contact ratio of the conveyor belt 36 is no less than about 0.1 and is no greater than about 0.2. In other embodiments, the contact ratio of the conveyor belt 36 is no less than about 0.13 and is no greater than about 0.17. In still other embodiments, the contact ratio of the conveyor belt 36 is no less than about 0.15.

Although the illustrated construction is directed towards a belt 36 formed from a plurality of spiral members 72 and cross supports 76. The belt 36 may be formed from any number and materials and uniquely shaped links able to support one or more food items F and convey them through the tunnel 28 of the oven 20. Furthermore, the belt 36 may be formed of a single piece of conductive, flexible material having a plurality of holes or recesses defined therein.

1. A conveyor oven for cooking food products, the conveyor oven comprising:
a housing;
a cooking tunnel extending through the housing;
a heating element; and
a conveyor belt extending through the tunnel and having a surface area configured to support the food product thereon,
wherein the ratio of the portion of the surface area of the conveyor belt in contact with a food product to the portion of the surface area of the conveyor belt covered by the food product is between about 0.1 and about 0.2.

2. The conveyor oven of claim 1, wherein the ratio is between about 0.13 and about 0.17.

3. The conveyor oven of claim 1, wherein the ratio is about 0.15.

4. The conveyor oven of claim 1, wherein the conveyor belt includes a plurality of spiral members, each formed from wire material and coupled to one another by a plurality of laterally extending cross supports.

5. The conveyor oven of claim 4, wherein the wire material is substantially ribbon-like and includes a planar width and an upper surface having a width, and wherein the width of the upper surface is at least about 90% of the planar width.

6. The conveyor oven of claim 4, wherein each spiral member is wound in the same direction.

7. The conveyor oven of claim 4, wherein a first portion of the spiral members are wound in a clockwise direction, and wherein a second portion of the spiral members are wound in a counter-clockwise direction.

8. A conveyor oven for cooking food product, the conveyor oven comprising:
a housing;
a cooking tunnel extending through the housing;
a heating element; and
a conveyor belt extending through the tunnel and having an upper portion including a surface configured to support the food product and a plurality of spaces formed therethrough which an axis normal to the support plane may pass without intersecting any material,
wherein the ratio of the combined area of the spaces of the support surface to the total area of the support surface is between about 0.5 and about 0.65.

9. The conveyor oven of claim 8, wherein the ratio is between about 0.55 and about 0.65.

10. The conveyor oven of claim 8, wherein the ratio is about 0.56.

11. The conveyor oven of claim 8, wherein the conveyor belt includes a plurality of spiral members, each formed form wire material and coupled to one another by a plurality of laterally extending cross supports.

12. The conveyor oven of claim 11, wherein the conveyor belt defines a coil separation ratio between about 0.66 and about 0.78.

13. The conveyor oven of claim 11, wherein the conveyor belt defines a coil concentration between about 4.8 and about 5.4.

14. The conveyor oven of claim 11, wherein the conveyor belt defines a coil density between about 2 and about 2.8.

15. A conveyor oven for cooking food products, the conveyor oven comprising:
a housing;
a cooking tunnel extending through the housing;
a heating element; and
a conveyor belt extending through the tunnel and having a surface area configured to support the food product thereon,
wherein the conveyor belt is formed from wire defining a first width and including a contact surface defining a second width, and wherein the second width of the contact surface is at least about 90% of the first width.

16. The conveyor oven of claim 15, wherein the wire material forms one or more spiral members.

17. The conveyor oven of claim 16, wherein the spiral members are coupled to one another by a plurality of laterally extending cross supports.
